(19) United States
(12) Patent Application Publication
(10) Pub. No.: US 2010/0145767 A1
(43) Pub. Date: Jun. 10, 2010

(54) SYSTEMS AND METHODS FOR ANALYZING A CONTRACT

(76) Inventors: Richard Scott Snow, Roswell, GA (US); Mark Andrew Bahr, Marietta, GA (US); Neal Lewis Zaher, Decatur, GA (US)

Correspondence Address: SUTHERLAND ASBILL & BRENNAN LLP, 999 PEACHTREE STREET, N.E., ATLANTA, GA, 30309, US

(21) Appl. No.: 12/329,278

(22) Filed: Dec. 5, 2008

(51) Int. Cl. G06Q 10/00

(52) U.S. Cl. 705/10; 705/7

(57) ABSTRACT

Embodiments of the invention can provide systems and methods for analyzing a contract. According to one embodiment, a computer-implemented method for estimating a contract's profitability and risk exposure using various contract terms, potential cash flows, and pricing strategies can be provided. By estimating the contract's profitability and risk exposure across a variety of conditions, a valuation-risk profile is determined and can be presented to a user. The valuation-risk profile provides an objective value of any particular contract component and a quantitative framework for negotiation purposes. In addition, the valuation-risk profile can be used as part of a larger strategic plan, for risk assessment, and for general decision-making.

### FIELD OF THE INVENTION

The invention relates to systems and methods for contract analysis, and more particularly, to systems and methods for analyzing a contract.

### BACKGROUND OF THE INVENTION

Generally, parties desiring to contract with each other may negotiate contractual terms to leverage expertise, manage expectations, or hedge against certain respective risk. When doing so, the parties may negotiate over any number of terms to obtain certain contract benefits but without full knowledge of future conditions. In general, when future conditions change, the contract's future value changes. In many instances, changes in future conditions may have been contemplated during contract negotiation, but their impacts to the contract's value not understood. This creates risk. For example, fluctuations in inflation, instability in geopolitics, deterioration in natural environments, and other events can erode any number of assumptions behind either or both parties' respective contractual strategies, and thereby affect a contract's profit margins.

These risks associated with the future may or may not be manageable during contract negotiation. If the contract is relatively simple and its duration short, then parties are better positioned to foresee and estimate their risk exposure using present knowledge. If the contract is complex or negotiated for longer periods of time, the less reliable present knowledge becomes. Coinciding with this breakdown in reliability can be a breakdown in sophistication. Rather than negotiate a contract using a reasonably accurate estimation of the future and the impact individual terms may have on the contract's overall profitability and risk, parties may negotiate in an ad hoc manner using intuition and anecdotal knowledge. This can result in a contract with indeterminable risk exposure, making it more difficult to standardize contractual negotiation, and obscuring the contract's future value.

Thus, there is a need for systems and methods for analyzing a contract. There is a further need for systems and methods for analyzing a contract in terms of valuation and risk.

### BRIEF DESCRIPTION OF THE INVENTION

Embodiments of the invention can address some or all of the needs described above. Certain embodiments of the invention are directed generally to systems and methods for analyzing a contract. Certain other embodiments of the invention are directed to systems and methods for analyzing a contract in terms of valuation and risk. According to one embodiment, a computer-implemented method for analyzing a contract can be provided. The method can include receiving one or terms of the contract to be analyzed. The method can also include receiving one or more cash flows associated with the contract. Furthermore, the method can include receiving at least one pricing strategy for analyzing the contract. Finally, the method can include estimating at least one valuation-risk profile associated with the contract using the pricing strategies, the cash flows, and the contract terms.

According to another embodiment of the invention, a computer-implemented method for analyzing a contract using a monte carlo simulation can be provided. The method can include receiving one or terms of the contract to be analyzed. The method can also include receiving one or more cash flows associated with the contract. Furthermore, the method can include receiving at least one pricing strategy for analyzing the contract. Finally, the method can include using a monte carlo simulation to estimate at least one valuation-risk profile associated with the contract using the pricing strategies, the cash flows, and the contract terms.

According to yet another embodiment of the invention, a system for analyzing a contract can be provided. The system can include an analysis module adapted to receive the one or more contract terms. The analysis module can be adapted further to receive the one or more cash flows associated with the contract. The analysis module can also be adapted to receive at least one pricing strategy for analyzing the contract. Finally, the analysis module can be adapted to determine at least one estimated valuation-risk profile associated with the contract using the pricing strategies, the cash flows, and the contract terms.

Other embodiments and aspects of the invention will become apparent from the following description taken in conjunction with the following drawings.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example system for analyzing a contract according to one embodiment of the invention.

FIG. 2 is a flowchart illustrating an example method for analyzing a contract according to one embodiment of the invention.

FIG. 3 illustrates an example chart for providing a contract's cost basis, cash flow, and duration term according to one embodiment of the invention.

FIG. 4 illustrates an example chart for providing a contract's termination term according to one embodiment of the invention.

FIG. 5 illustrates an example chart for providing one or more pricing strategies to be used when analyzing a contract according to one embodiment of the invention.

FIG. 6 illustrates an example chart for comparing one or more pricing strategies to be used when analyzing a contract against each other and against a risk methodology according to one embodiment of the invention.

FIG. 7 illustrates an example chart for providing contract valuation-risk profiles in tabular form according to one embodiment of the invention.

FIG. 8 illustrates an example chart for providing contract valuation-risk profiles in graphical form according to one embodiment of the invention.

### DETAILED DESCRIPTION OF THE INVENTION

The invention now will be described more fully hereinafter with reference to the accompanying drawings, in which example embodiments of the invention are shown. This invention may, however, be embodied in many different forms and should not be construed as limited to the example embodiments set forth herein; rather, these embodiments are provided so that this disclosure will convey the scope of the invention to those skilled in the art. Like numbers refer to like elements throughout.

Certain embodiments of the invention can be implemented within a quality improvement process and system. In one embodiment, a method for analyzing a contract, also known as a method for estimating its profitability and risk exposure, is performed by a business team to determine the contract's vulnerability to various environmental conditions. Environmental conditions can be narrowly or broadly defined and can reflect variations such as those in the natural environment, the trade environment, the labor environment, the financial environment, and the geopolitical environment. Using this information, the business team can make informed, objective decisions when negotiating or renegotiating any individual contractual term to meet organizational goals. Accordingly, certain embodiments of the invention described herein may facilitate the avoidance of subjective determinations regarding the criticality of such terms. Instead, criticality can be tied to impacts on profit margin and risk exposure as revealed by various environmental conditions that may potentially exist in the future. Thus, at least one technical effect is to provide a profit and risk assessment for individual contractual terms.

In addition, certain embodiments of the invention can be implemented in a business planning process and system. By doing so, a financial analyst, or other individual or entity analyzing a contract, may make informed decisions as to how other contracts should be negotiated, how certain costs should be managed in light of risk, and how standard, default contractual terms should be defined. Conventional tools and methods are not currently known to provide relatively robust and objective evaluations of a contract's terms according to profit margin and risk. Certain embodiments of the invention described herein can facilitate analyzing differing contractual terms across multiple conditions, profiles, and in relation to each other to determine their impact on the contract's overall profit margin and risk exposure.

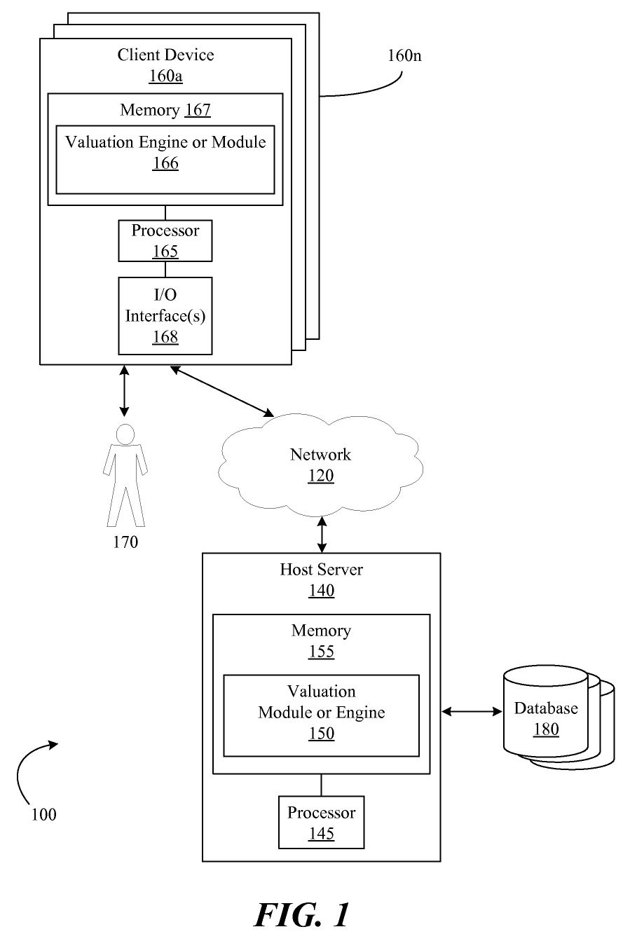

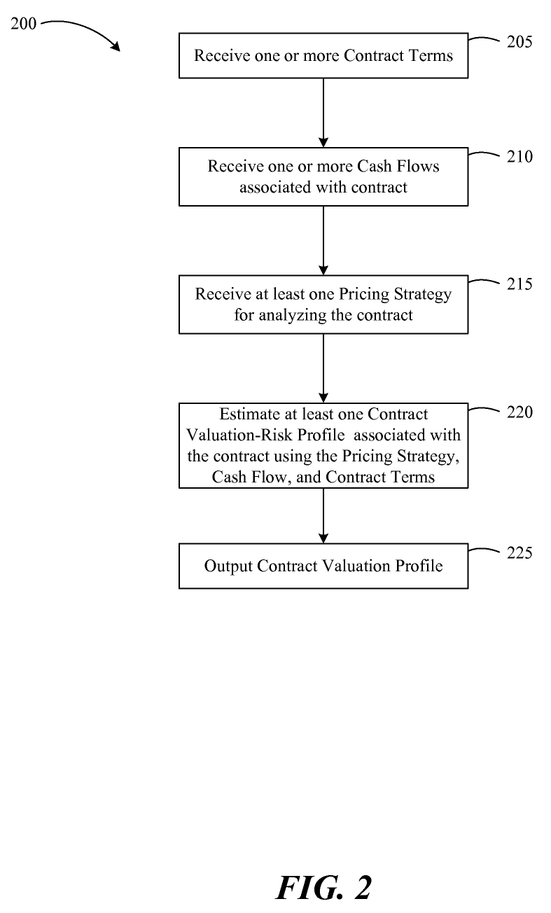

FIG. 1 illustrates an example system 100 for analyzing the profitability of a contract according to one embodiment of the invention. In one example, the system 100 can implement a method, shown as 200 in FIG. 2. In another example, the system 100 can implement some or all of the processes, techniques, and methodologies described with respect to FIGS. 2-8.

The system 100 is shown with a communications network 120 in communication with at least one client device 160a. Any number of other client devices 160n can also be in communication with the network 120. In this embodiment, at least one of the client devices 160a-n can be associated with an entity such as a financial analyst, a business manager, or a contract negotiation team, wherein each client device 160a-n may be associated with a respective entity analyzing a contract's terms according to particular predefined profit margin and risk exposure.

The communications network 120 shown in FIG. 1 can be a wireless communications network capable of transmitting both voice and data signals, including image data signals or multimedia signals. Other types of communications networks can be used in accordance with various embodiments of the invention.

Each client device 160a-n can be a computer or processor-based device capable of communicating with the communications network 120 via a signal, such as a wireless frequency signal or a direct wired communication signal. Each client device, such as 120a, can include a processor 165 and a computer-readable medium, such as a random access memory (RAM) 167, coupled to the processor 165. The processor 165 can execute computer-executable program instructions stored in memory 167. Computer executable program instructions stored in memory 167 can include a contract analysis module application program, or contract analysis engine or module 166. The contract analysis engine or module 166 can be adapted to receive one or more signals from one or more entities such as financial analysts, business managers, or contract negotiation teams. Other examples of functionality and aspects of embodiments of a contract analysis engine or module 166 are described below.

One embodiment of a contract analysis engine or module, such as 166, can include a main application program process with multiple threads. Another embodiment of a contract analysis engine or module can include different functional modules. An example of one programming thread or functional module can be a module for communicating with a contract negotiation team member. Another programming thread or module can be a module for communicating with a business manager. Yet another programming thread or module can provide communications and exchange of data between a contract negotiation team member and a business manager. One other programming thread or module can provide database management functionality, including storing, searching, and retrieving data, information, or data records from a combination of databases, data storage devices, and one or more associated servers.

Suitable processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 165, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, a private or public network, or another transmission device or channel, both wired and wireless. The instructions may comprise code from any computer-programming language, including, for example, C, C++, C#, Visual Basic, Java, Python, Perl, and JavaScript.

Client devices 160a-n may also comprise a number of external or internal devices such as a mouse, a CD-ROM, DVD, a keyboard, a display, or other input or output devices. As shown in FIG. 1, a client device such as 160a can be in communication with an output device via an I/O interface, such as 168. Examples of client devices 160a-n are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 160a, may be any type of processor-based platform that is connected to a network, such as 120, and that interacts with one or more application programs. Client devices 160a-n may operate on any operating system capable of supporting a browser or browser-enabled application, such as Microsoft® Windows® or Linux. The client devices 160a-n shown include, for example, personal computers executing a browser application program such as Microsoft Corporation's Internet Explorer™, Netscape Communication Corporation's Netscape Navigator™, and Apple Computer, Inc.'s Safari™.

In one embodiment, suitable client devices can be standard desktop personal computers with Intel x86 processor architecture, operating a LINUX operating system, and programmed using a Java language.

A user, such as 170, can interact with a client device, such as 160a, via an input device (not shown) such as a keyboard or a mouse. For example, a user can input information, such as contractual data associated with a contract, risk-related information, or information associated with profitability, via the client device 160a. In another example, a user can input contractual information via the client device 160a by keying text via a keyboard or inputting a command via a mouse.

Memory, such as 167 in FIG. 1 and described above, or another data storage device, such as 180 described below, can store information associated with a contract and a contract valuation-risk profile for subsequent retrieval. In this manner, the system 100 can store contractual information and contract analysis information in memory 167 associated with a client device, such as 160a or a desktop computer, or a database 180 in communication with a client device 160a or a desktop computer, and a network, such as 120.

The memory 167 and database 180 can be in communication with other databases, such as a centralized database, or other types of data storage devices. When needed, data stored in the memory 167 or database 180 may be transmitted to a centralized database capable of receiving data, information, or data records from more than one database or other data storage devices.

The system 100 can display contractual information and contract analysis information via an output device associated with a client device. In one embodiment, contractual information and contract analysis information can be displayed on an output device, such as a display, associated with a remotely located client device, such as 160a. Suitable types of output devices can include, but are not limited to, private-type displays, public-type displays, plasma displays, LCD displays, touch screen devices, and projector displays on cinema-type screens.

The system 100 can also include a server 140 in communication with the network 120. In one embodiment, the server 140 can be in communication with a public switched telephone network. Similar to the client devices 160a-n, the server device 140 shown comprises a processor 145 coupled to a computer-readable memory 155. In the embodiment shown, a contract analysis module 150 or engine can be stored in memory 155 associated with the server 140. The server device 140 can be in communication with a database, such as 180, or other data storage device. The database 180 can receive and store data from the server 140, or from a client device, such as 160a, via the network 120. Data stored in the database 180 can be retrieved by the server 140 or client devices 160a-n as needed.

The server 140 can transmit and receive information to and from multiple sources via the network 120, including a client device such as 160a, and a database such as 180 or other data storage device.

Server device 140, depicted as a single computer system, may be implemented as a network of computer processors. Examples of suitable server device 140 are servers, mainframe computers, networked computers, a processor-based device, and similar types of systems and devices. Client processor 165 and the server processor 145 can be any of a number of computer processors, such as processors from Intel Corporation of Santa Clara, Calif., AMD Corporation of Sunnyvale, Calif., and Motorola Corporation of Schaumburg, Ill. The computational tasks associated with rendering a graphical image could be performed on the server device(s) and/or some or all of the client device(s).

An example method 200 for analyzing, or estimating the profitability and risk exposure of a contract is shown in FIG. 2. The example method 200 shown is a method for analyzing a contract provided by a user. The method can be, for example, implemented by a system 100 described above and shown in FIG. 1.

The method 200 begins at block 205. In block 205, a contract ripe for analysis is defined according to its terms. For example, in one embodiment, a user can define a contract using default terms as set by standard policies, plans, or practices. In another embodiment, a user can begin with a default contract and vary its terms to study the effects any one term or combination of terms has on a contract's profitability and risk exposure. In yet another embodiment, a system can analyze a contract, vary individual terms methodically to discover their effects on profitability and risk, optimize the contract by varying terms and comparing profitability and risk information, and define a contract according to a default profile determined by one or more of the embodiments above. Other embodiments will be apparent after reading this disclosure.

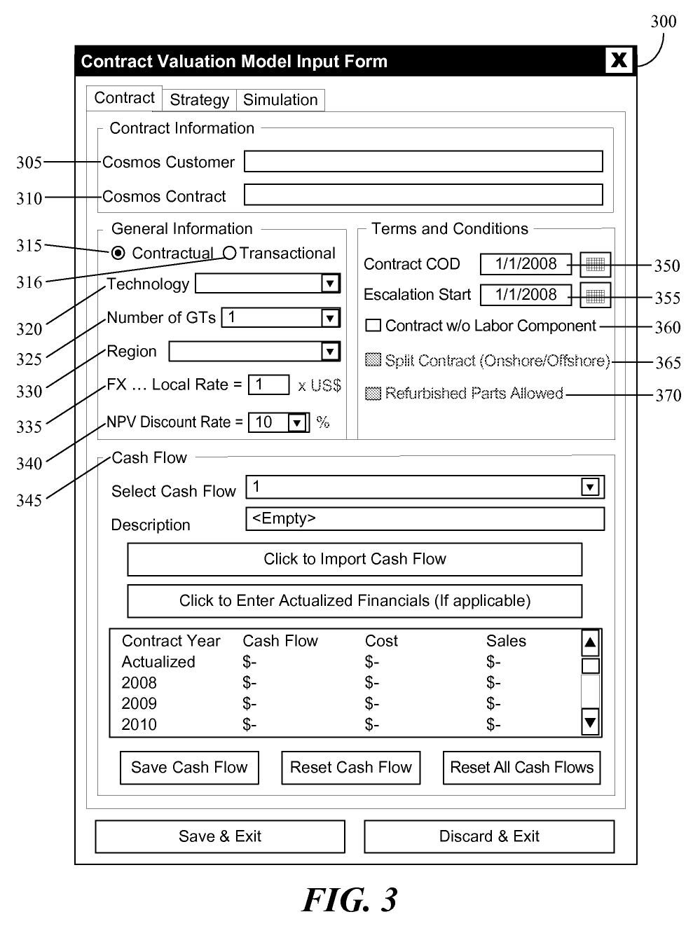

It will be appreciated that the terms defining a contract can be both numerous and diverse. FIG. 3 illustrates an exemplary embodiment of a user interface 300 with any number of fields, pull down menus, radio buttons, and other input devices for inputting such terms. In the embodiment shown in FIG. 3, a user can input at least one customer term 305, at least one contract term 310, at least one contractual term 315, and at least one transactional term 316. Terms 305, 310, 315, and 316 represent exemplary defining terms of an exemplary contract, which may subsequently be used to establish the terms of the contract, to store the terms of the contract, or to import the terms of the contract from a file external to the system. In one embodiment, defining terms can include one or more of the following: at least one cost basis, at least one duration term, at least one termination term, and one or more adjustment factors.

In one embodiment, cost basis can be defined as a fixed cost or multiple fixed costs. In another embodiment, cost basis can be defined as a variable cost or multiple variable costs. In yet another embodiment, cost basis can be defined as a percentage of fixed costs or variable costs. In still yet another embodiment, cost basis can be defined as multiple percentages of fixed costs or variable costs. It will be appreciated that contracts generally contain costs that can be categorically separated. In a services contract, for example, cost basis can be separated into costs associated with labor, parts, and energy, and defined as a percentage of these costs. It will be further appreciated that costs associated with labor, parts, and energy can be fixed for the contract term or they can vary. In one embodiment, these costs are shown in FIG. 3.

In FIG. 3, at least one cost basis can be defined by a user at field 320. Because a contract's cost basis can vary over the contract term, in the embodiment shown, any number of adjustment factors can be used to represent these expected fluctuations. Adjustment factors can reflect changes in any one or more of the following: regional differences, currency differences, or contractual peculiarities. For example, as shown in FIG. 3, adjustment factor 330 can represent an adjustment for labor costs as they relate to a particular region. Similarly, adjustment factors 335 and 340 can reflect adjustments for monetary differences as they relate to a region and/or time. Adjustment factors 360, 365, and 370 can represent adjustments to the contract's cost basis given certain peculiarities to the contract that may cause it to deviate from the standard cost basis defined at field 320. It will be appreciated that in addition to the above, additional adjustment factors may also be used to suitably describe the contract's terms and associated peculiarities.

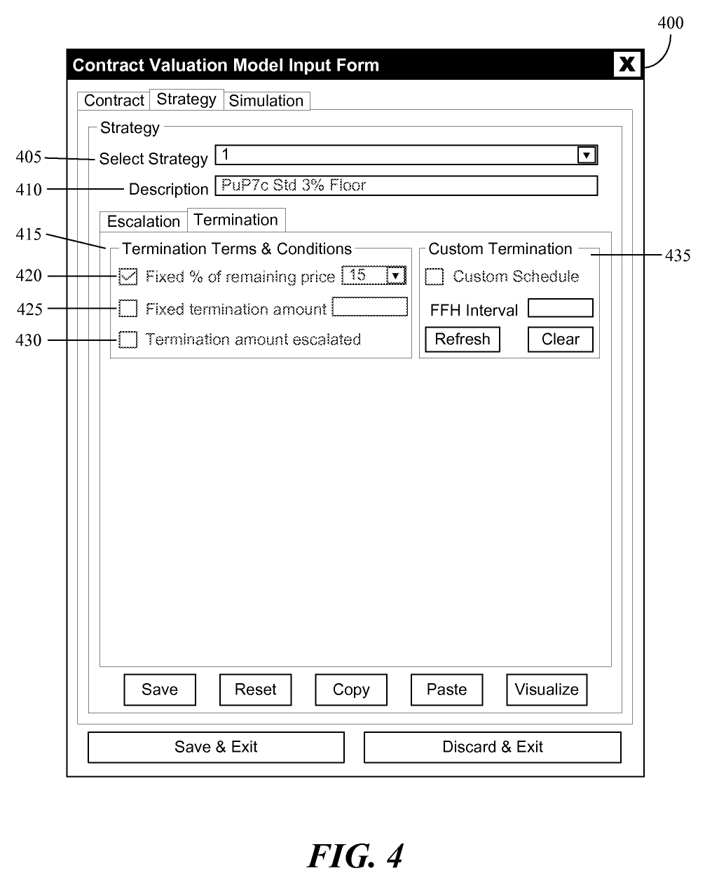

In the exemplary embodiment, other terms used to define the contract under analysis can be at least one duration term 350 and at least one termination term 415. In the embodiment shown in FIG. 4, the contract's termination term 415 can be defined in multiple ways. For example, the termination term can be defined as a fixed percentage of the remaining price 420, as a fixed amount 425, as a function of a pricing strategy 430 defined below, or according to a custom schedule 435 defined by an entity, such as the user or by a standard business development program, process, or team.

Referring back to the method 200 of FIG. 2, block 205 is followed by block 210, wherein one or more cash flows are received for the contract defined at block 205. In the exemplary embodiment, cash flow can be defined in FIG. 3 at field 345. A contract's cash flow can reflect at least two values: (1) the value to be received as revenue during one or more accounting periods or subsets of accounting periods; and (2) the value to paid as costs during one or more accounting periods or subsets of accounting periods. When more than one accounting period is used, it will be appreciated that cash flow can vary over the multiple periods, whether day-to-day, month-to-month, year-to-year, or any other period defined by one or more parties to the contract. As one may recognize, there are any number of reasons why a contract's cash flow can vary. For example, cash flows can vary according to the terms of the contract, changes in supply and demand curves, maturations in product development cycles, and changes in international, regional, or domestic law. For these reasons, in the embodiment shown, when analyzing a contract and its terms, a user can define cash flow as either fixed or variable. In addition, the embodiment illustrates that one can analyze one or more contracts over multiple cash flows that can be either fixed or variable to reveal cash flow effects on valuation and risk.

At block 215, at least one pricing strategy is received for analyzing the contract. Pricing strategy can reflect how the contract will be priced over one or more accounting periods. In one embodiment, a pricing strategy can define the total revenue received under the contract for one or more accounting periods. In another embodiment, a pricing strategy can define the profit margin for the contract during one or more accounting periods. In the embodiment shown, a pricing strategy can define one or more fixed or variable terms to be applied to the contract's remaining terms or cost basis to determine the contract's price for one or more accounting periods.

It will be appreciated that a contract can be priced in a number of ways including, but not limited to, fixed fee pricing, cost reimbursement pricing, cost reimbursement plus award pricing, standard escalation pricing, standard escalation pricing subject to limits, and variable escalation pricing. Other pricing strategies may be utilized in other embodiments of the invention.

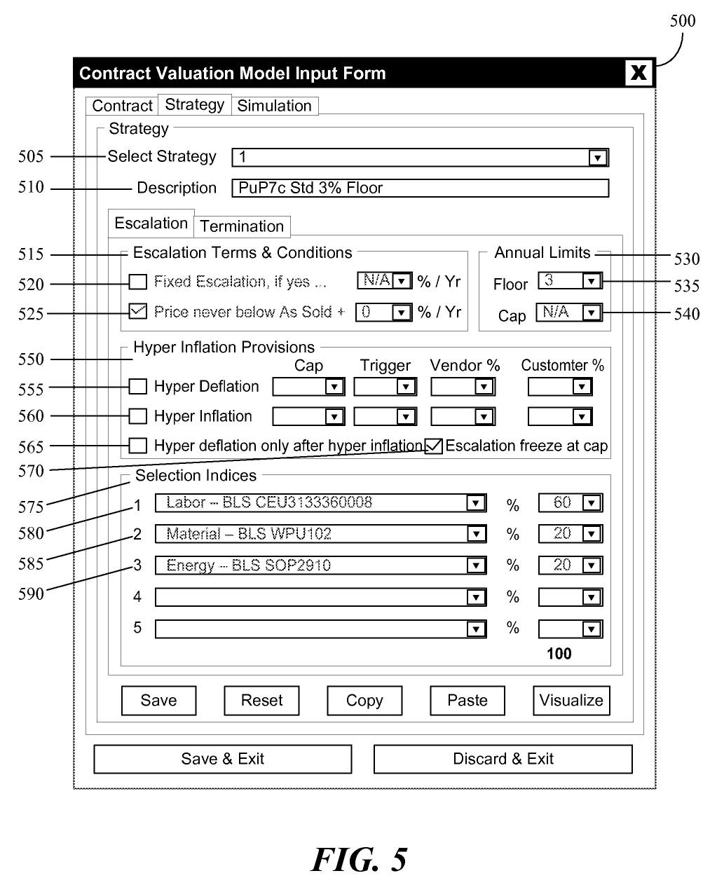

In the exemplary embodiment, a pricing strategy can be defined and assigned identification labels in a user interface 500 as shown in FIG. 5. For example, when multiple pricing strategies are to be analyzed, one can assign respective identification tags to each strategy. Examples of these tags are shown as numeric identifier 505 and description identifier 510. These identification labels can enable a user to define multiple pricing strategies for one or more contracts so that multiple contract valuation-risk profiles can be readily compared as described below. Other strategy parameters, such as 515-590, can be used to define the pricing strategy and can include any number of numeric identifiers and/or description identifiers. For example, a fixed escalation term 520 can be set which escalates the contract's price by a fixed amount at the end of each accounting period. In another example, a variable escalation term 525 can be set which escalates the contract's price by a variable amount at the end of each of accounting period.

When a pricing strategy varies, it will be appreciated that to hedge against future risk due to nominal inflation, deflation, and other market fluctuations, parties to a contract may desire to limit the minimum or maximum changes in the contract's price that may occur during the contract's duration. In one embodiment, a user can specify certain annual limit preferences 530. For example, a user can define a floor term 535 that reflects the minimum price increase that will occur at the end of one accounting period. Alternatively, a user can define a cap term 540 that reflects the maximum price increase that will occur at the end of one accounting period. The floor term 535 and the cap term 540 are exemplary embodiments of terms defining a pricing strategy.

In addition to one or more of the terms described above, a pricing strategy can be further defined to hedge against one or more market extremes, such as defining certain hyper inflation provisions 550. For example, in FIG. 5, the pricing strategy can account for hyper deflation terms 555 and hyper inflation terms 560. Hyper deflation describes a period of extremely rapid deflation where the cost of goods drop at an extraordinary rate. Hyper inflation describes a period of extremely rapid inflation where the cost of goods rise at an extraordinary rate. When negotiating a contract, parties may desire to allocate the risk amongst themselves in the event such an extreme condition in the market emerges during the contract's duration. In one embodiment, a user can do this by refining the pricing strategy to include a cap on cost increases, a floor on cost decreases, a trigger for a hyper deflation or hyper inflation clause, and an allocation of costs between the vending party and the consuming party once that trigger is tripped. Moreover, a user can further refine the pricing strategy using term 565—where a hyper deflation clause is contingent only after the trigger of a hyper inflation clause—or term 570—where a hyper deflation or hyper inflation clause contains a modifier to cap term 540.

It will be appreciated that when a contract has many component parts, each of which determines its cost basis, it can be beneficial to define the pricing strategy as a function of individual component costs. In the exemplary embodiment, certain selection indices for a contract for services can be displayed at 575 along with cost components for labor 580, parts 585, and energy 590. In the embodiment shown in FIG. 5, a user can define the pricing strategy as a function of individual indices 575 associated with these components 580, 585, 590. By doing so, the pricing strategy can become a form of variable escalation pricing since the escalation in price varies according to variations in associated indices. It will be appreciated that these indices can be historically based, provided by a third party, or provided by one or more parties to the contract.

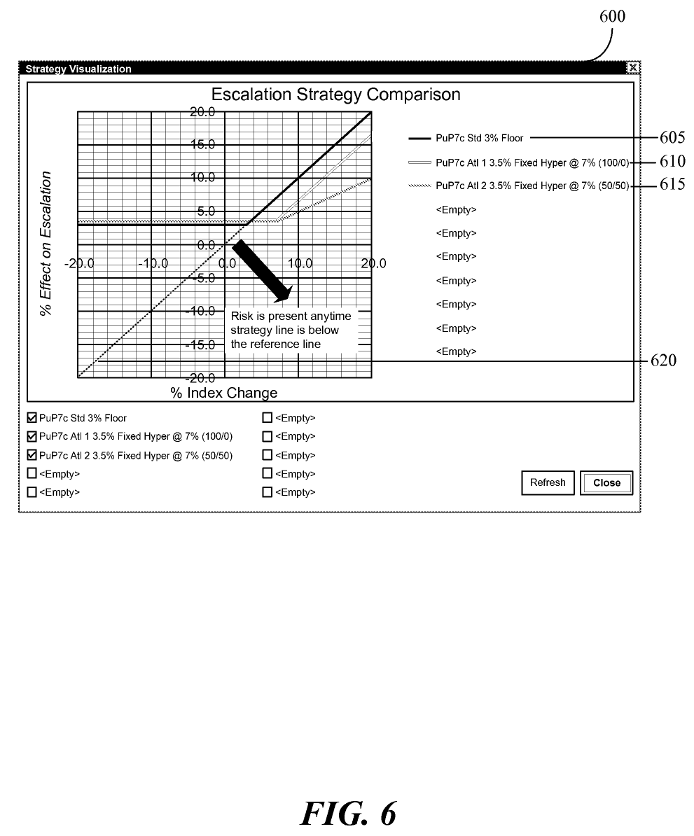

It will be appreciated that as a number of pricing strategies can be defined and tailored, they can likewise be compared. In FIG. 6, an exemplary comparison is provided where pricing strategies 605, 610, and 615, identified by a respective description identifier input at 510 in FIG. 5, can be displayed and compared to each other in conjunction with or against a threshold risk value 620. When analyzing one or more contracts, a comparison of multiple pricing strategies can be useful to preliminarily assess risk across multiple pricing strategies and to ensure the pricing strategy has been properly defined.

Referring back to method 200, in block 220, once the contract terms are received, the cash flows received, and the pricing strategies received, the method 200 can estimate a contract valuation-risk profile associated with the contract. The contract valuation-risk profile reflects the value of a contract over its total or partial duration. It need not be limited to contractual value, however. It can also reflect the value of any particular contractual term or combination of contractual terms. It will be appreciated that the contract valuation-risk profile can include copious amounts of information and can be presented as a single data point, a set of data points, a single data distribution, or a set of data distributions. Other embodiments of a contract valuation-risk profile can also be used and will be apparent after reading this disclosure.

In one embodiment, a monte carlo simulation is used to estimate the contract valuation-risk profile. A monte carlo simulation is a computational algorithm that relies on the repeated random sampling of a data set to compute results. In one embodiment, a contract valuation-risk profile is generated from a monte carlo simulation that randomly samples a data set associated with the contract's cost basis. This data set can be a user-defined data set, a multilaterally-defined data set, or a historically-based data set.

For example, when a services contract is to be analyzed, a cost basis can include costs associated with labor, parts, and energy. Costs associated with labor, parts, and energy vary daily, weekly, monthly, and yearly. These variations are reported by a variety of third party agencies such as the following: (1) the U.S. Department of Labor, which reports changes in the prices paid by urban consumers for a representative basket of goods and services in the form of the Consumer Price Index (CPI) and changes in the selling prices received by domestic producers for their output in the form of the Producer Price Index (PPI); (2) the U.S. Department of Energy, which reports a variety of information associated with the cost of various forms of energy; (3) the United Kingdom Statistics Authority, which reports a variety of information associated with costs in the U.K. economy; and (4) the Statistical Office of the European Communities, which reports regional information related to costs and fluctuations in the European economy. Thus, using data provided by these third parties, a data set associated with the contract's Cost Basis can be created. It will be appreciated that relying on third parties to generate a data set is only one embodiment of a method for doing so. Other embodiments can be implemented using any number of data sets from any number of other similar data sources. For example, parties could create a data set based on mutual agreement. As a result, additional methods for generating a data set can be used in place of the third party method described.

Pulling data values randomly from the data set, the monte carlo simulation calculates random changes to the contract's cost basis and then estimates the contract valuation-risk profile using the contract's terms, its cash flows, and its pricing strategies. In one embodiment, this simulation is reiterated at least 10,000 times to generate a statistically significant data distribution for each parameter within the contract valuation-risk profile.

It will be appreciated that any number of optimization techniques in addition to monte carlo simulations can be used to estimate a contract valuation-risk profile. For example, commercially available and suitable software tools such as the Crystal Ball™ software suite available from Oracle, Inc., GoldSim software available from GoldSim Technology Group, or @Risk software available from Palisade, can all be used to perform the optimization described and to analyze the contract. Other tools and techniques besides those described here will become apparent after reading this disclosure.

At block 225, the method 200 continues by outputting the contract valuation-risk profile. In one embodiment, the contract valuation-risk profile can be displayed to a user for further analysis, for reporting purposes, or for optimization purposes. In another embodiment, the contract valuation-risk profile is stored in a database or similar data storage device for later retrieval. In still yet another embodiment, the contract valuation-risk profile can be output in any combination of the others described. It will be appreciated that when a contract is analyzed using multiple pricing strategies, a plurality of contract valuation-risk profiles can also be supplied, stored, displayed, or analyzed further by a user.

The method 200 ends after block 225.

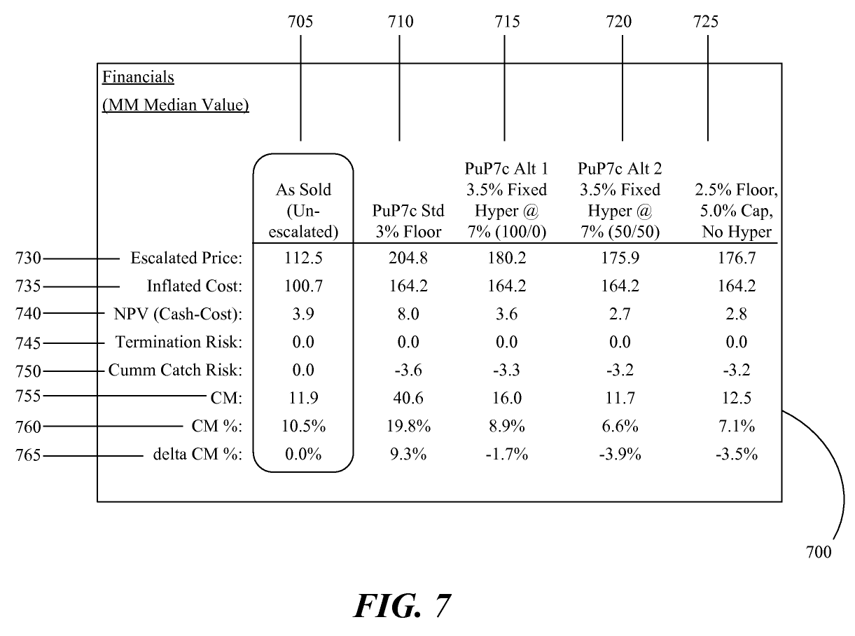

FIG. 7 is an exemplary embodiment of a plurality of contract valuation-risk profiles in tabular form 700. Columns 705, 710, 715, 720, and 725 each reflect contract valuation-risk profiles associated with particular pricing strategies identified by their respective description identifiers, input at 510 in FIG. 5. For example, pricing strategy as sold (un-escalated) 705 represents the total revenues for the contract's duration term assuming a constant, fixed fee price for each successive accounting period. Other valuation-risk profiles displayed reflect other pricing strategies previously provided by a user.

As previously described, a contract valuation-risk profile can reflect a number of values such as the value of a contract, the value of multiple contracts, the value of a contractual term, or the value of a combination of contractual terms. Value includes economic value, but it could also include a risk value, a preference value, or other known values. It will be appreciated that when economic value is desired, it can be further refined into one or more parameters associated with one or more aspects of economic value. Parameters associated with economic value can be one or more of a single data point, a set of data points, a single data distribution, or a set of data distributions. In one embodiment shown in FIG. 7, the contract valuation-risk profile contains a set of parameters reflecting economic value, where each parameter has a corresponding data distribution. Exemplary median values corresponding to exemplary individual contract valuation-risk profile parameters are displayed at 730, 735, 740, 745, 750, 755, 760, and 765. It will be appreciated that in addition to the median value, any value associated with a data distribution can also be determined and displayed including, but not limited to, the following: a mean value, an average value, a mode value, a range of values, and other known statistical values.

In the exemplary embodiment, multiple profile parameters define the contract valuation-risk profile. Escalated price parameter 730 represents the total revenues for the contract's duration term based on pricing strategies 705-725, which can each include an escalation term previously defined at 515 in FIG. 5. Inflated cost parameter 735 represents the total cost basis for the contract's duration term accounting for inflationary and deflationary periods modeled in the simulation. Including both or either parameter in the contract valuation-risk profile provides a user a glimpse at potential revenues and costs for negotiation purposes, profit estimation purposes, and for further contract refinement.

Net present value parameter 740 represents the total present value of a time series of cash flows. It provides an appraisal of long-term contracts using the time value of money. Termination risk parameter 745 represents any single year loss that may be incurred when the contract is terminated early based on the contract's previously defined termination term, shown as 415 in FIG. 4.

Cumm catch risk parameter 750 represents whether actual profits are greater than or less than forecasted profits for a given accounting period. Including it in the contract valuation-risk profile provides insight into whether a pricing strategy is likely to generate less revenue than expected. CM parameter 755 represents the contract's contribution margin, which is the contract's marginal profit. In the exemplary embodiment, it reflects the difference in the contract's total revenues under a given pricing strategy and its total cost basis. CM % parameter 760 represents the contract's contribution margin percentage, also known as the contribution margin divided by the total contract revenues. A contribution margin percentage indicates a degree of profitability for a given pricing strategy because it reflects a profit output for a given cost input. Delta CM % parameter 765 represents a percentage difference change between a contribution margin percentage for pricing strategies 710-725 and the contribution margin percentage for pricing strategy as sold (un-escalated) 705. In the exemplary embodiment, this parameter reflects the profitability of a given pricing strategy in relation to a fixed fee arrangement.

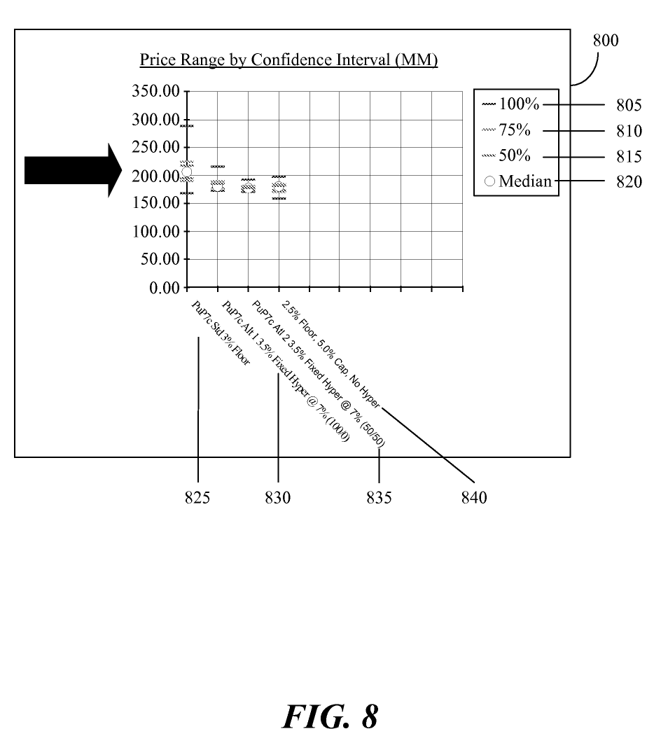

FIG. 8 displays an exemplary embodiment of a contract valuation-risk profile in graphical form 800. In FIG. 8, escalation price parameter 730 is displayed for contract valuation-risk profiles 710, 715, 720, and 725 in FIG. 7. As described above, in one embodiment, the contract valuation-risk profile is defined as a set of parameters each with associated data distributions. One of these parameters is a confidence indicator, shown as 805, 810, and 815 in conjunction with a median value for the data distribution at 820. Confidence indicators can provide a user a glimpse at the underlying data distribution for a given parameter. In one embodiment, the confidence indicator identifies the maximum and minimum values associated with a parameter's data distribution. For example, at 825, the median value 820 associated with contract valuation-risk profile 710 from FIG. 7 is displayed. Confidence indicator 805 can display the range surrounding the median where one hundred percent of the escalation price parameters generated by the simulation are located; confidence indicator 810 can display the range surrounding the median where seventy-five percent of the escalation price parameters generated by the simulation are located; confidence indicator 815 can display the range surrounding the median where about fifty percent of the escalation price parameters generated by the simulation are located. Using some or all of the disclosed confidence indicators, a user can compare various pricing strategies according to any one or more of the parameters in the plurality of contract valuation-risk profiles. Moreover, by modifying one or more of the contract terms, cash flows, and pricing strategies successively, a contract can be optimized to meet a desired contract valuation-risk profile.

Embodiments of the invention are described above with reference to block diagrams and schematic illustrations of methods and systems according to embodiments of the invention. It will be understood that each block of the diagrams, and combinations of blocks in the diagrams can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A computer-implemented method for analyzing a contract comprising:
receiving, by a processor, one or more contract terms;
receiving, by a processor, one or more cash flows associated with the contract;
receiving, by a processor, at least one pricing strategy for analyzing the contract; and
estimating, by a processor, at least one valuation-risk profile associated with the contract based at least in part on the at least one pricing strategy, the one or more cash flows, and the one or more contract terms.

2. The method of claim 1, further comprising:
outputting, by a processor, at least one estimated valuation-risk profile.

3. The method of claim 1, further comprising:
generating, by a processor, one or more reports associated with at least one selected estimated valuation-risk profile.

4. The method of claim 1, wherein receiving one or more contract terms comprises:
receiving at least one cost basis associated with the contract;
receiving at least one duration term associated with the contract; and
receiving at least one termination contract term.

5. The method of claim 4, wherein the at least one cost basis associated with the contract comprises at least one of the following: costs associated with labor, costs associated with material, and costs associated with energy.

6. The method of claim 1, wherein estimating comprises applying, by a processor, at least one of a monte carlo simulation or an optimization methodology.

7. The method of claim 1, wherein the at least one estimated valuation-risk profile comprises a plurality of estimated valuation-risk profiles, and the method further comprises:
outputting, by a processor, the plurality of estimated valuation-risk profiles for comparison.

8. The method of claim 1, wherein the at least one estimated valuation-risk profile comprises at least one of: an escalated price, an inflated cost, a net present value (cash cost), a termination risk value, a cumm catch risk value, a contribution margin, a contribution margin percentage, or a percentage difference change between a contribution margin percentage and an as sold (un-inflated) contribution margin percentage, or a confidence indicator.

9. The method of claim 1, wherein the at least one estimated valuation-risk profile comprises a graphical presentation of data associated with estimated profitability and risk exposure.

10. The method of claim 1, further comprising:
receiving from a user at least one pricing strategy to analyze the contract.

11. A system for analyzing a contract, the system comprising:
an analysis module adapted to:
receive one or more contract terms;
receive one or more cash flows associated with the contract;
receive at least one pricing strategy for analyzing the contract; and
determine at least one estimated valuation-risk profile associated with the contract based at least in part on the at least one pricing strategy, the one or more cash flows, and the one or more contract terms.

12. The system of claim 11, wherein the profitability module is further adapted to:
output at least one estimated valuation-risk profile.

13. The system of claim 11, wherein the analysis module is further adapted to:
estimate a plurality of valuation-risk profiles; and
output a plurality of estimated valuation-risk profiles.

14. The system of claim 11, wherein the analysis module is further adapted to:
store one or more estimated valuation-risk profiles associated with the contract.

15. The system of claim 14, further comprising:
a memory device adapted to store information associated with the valuation-risk profile of the contract.

16. The system of claim 11, wherein the analysis module is further adapted to:
generate one or more reports associated with at least one selected estimated valuation-risk profile.

17. The system of claim 11, wherein the analysis module is further adapted to:
perform a monte carlo simulation or an optimization methodology.

18. The system of claim 11, further comprising:
an output device adapted to display information associated with the valuation-risk profile of the contract.

19. The system of claim 11, further comprising:
a server adapted to communicate information associated with the valuation-risk profile of the contract to a network.

20. A computer-implemented method for analyzing a contract using a monte carlo simulation comprising:
receiving, by a processor, one or more contract terms;
receiving, by a processor, one or more cash flows associated with the contract;
receiving, by a processor, at least one pricing strategy for analyzing the contract;
estimating, by a processor, at least one valuation-risk profile associated with the contract using a monte carlo simulation and based at least in part on the at least one pricing strategy, the one or more cash flows, and the one or more contract terms; and
outputting, by a processor, at least one valuation-risk profile for the contract.
